(19) United States
(12) Patent Application Publication
(10) Pub. No.: US 2005/0230933 A1
(43) Pub. Date: Oct. 20, 2005

(54) COLLAPSABLE BICYCLE

(76) Inventor: Ming Feng Woo, Daichia Village (TW)

Correspondence Address: Keith Kline;PRO-TECHTOR INTERNATIONAL SERVICES, 20775 Norada Court, Saratoga, CA, 95070-3018, US

(21) Appl. No.: 10/818,795

(22) Filed: Apr. 5, 2004

(51) Int. Cl. B62M 15/00

(52) U.S. Cl. 280/278

(57) ABSTRACT

A collapsable bicycle comprises a link including a first locking device at one end slidably sleeved on and fastened at rear of a crossbar, a second locking device at the other end fastened a seat post at top of a seat tube, two down tubes having one ends pivotably coupled to rear of the crossbar, the down tubes having a pivot point coupled to a bottom end of the seat tube, a rear wheel rotatably coupled to rear of the down tubes, and a chain drive mounted between the rear wheel and the down tubes. Unfastening the quick releases and sliding the first locking device forwardly will move the rear wheel forwardly by pivoting about the rear of the crossbar, move the front wheel rearward, and move the down tubes toward the seat tube by pivoting about the pivot point until the seat tube is engaged with the down tubes.

### BACKGROUND OF THE INVENTION

1. Field of the Invention

The present invention relates to bicycles and more particularly to a collapsable bicycle with improved characteristics.

2. Description of Related Art

Collapsable bicycles are gaining popularity recently due to its convenience in parking, storage or shipping. However, folding portions (e.g., latches) of a conventional collapsable bicycle tend to malfunction after a short period of time of use. This can adversely affect the safety of driving. Thus, the need for improvement still exists.

### SUMMARY OF THE INVENTION

It is an object of the present invention to provide a collapsable bicycle, comprising a head comprising a pair of handlebars, a height adjustable head tube, a front wheel, and a crossbar; a seat comprising a seat, a sliding seat post, and a seat tube; a tube section comprising a link including a first locking device at one end slidably sleeved on and fastened at a rear portion of the crossbar, a second locking device at the other end fastened the seat post at a top end of the seat tube, and a pair of down tubes having one ends pivotably coupled to a rear end of the crossbar, the down tubes having a pivot point coupled to a bottom end of the seat tube; a rear wheel rotatably coupled to a rear end of the down tubes; and a chain drive mounted between the rear wheel and the down tubes, whereby unfastening the first and the second quick releases and sliding the unfastened first locking device forwardly will move the rear wheel forwardly by pivoting about the rear end of the crossbar, move the front wheel rearward, and move the down tubes toward the seat tube by pivoting about the pivot point until the seat tube is parallel to and is engaged with the down tubes.

In one aspect of the present invention there is further provided two side auxiliary wheels coupled to a hub of the rear wheel.

In another aspect of the present invention there is further provided a brace (e.g., shock absorber) coupled between the chain drive and the first locking device.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of collapsable bicycle according to the invention, where the bicycle is extended to be ready to drive;.

FIG. 2 is a side view of the bicycle in FIG. 1;

FIG. 3 is a side view of the collapsed bicycle; and

FIG. 4 is a rear view of the bicycle in FIG. 3.

### DETAILED DESCRIPTION OF THE PREFERRED EMBODIMENTS

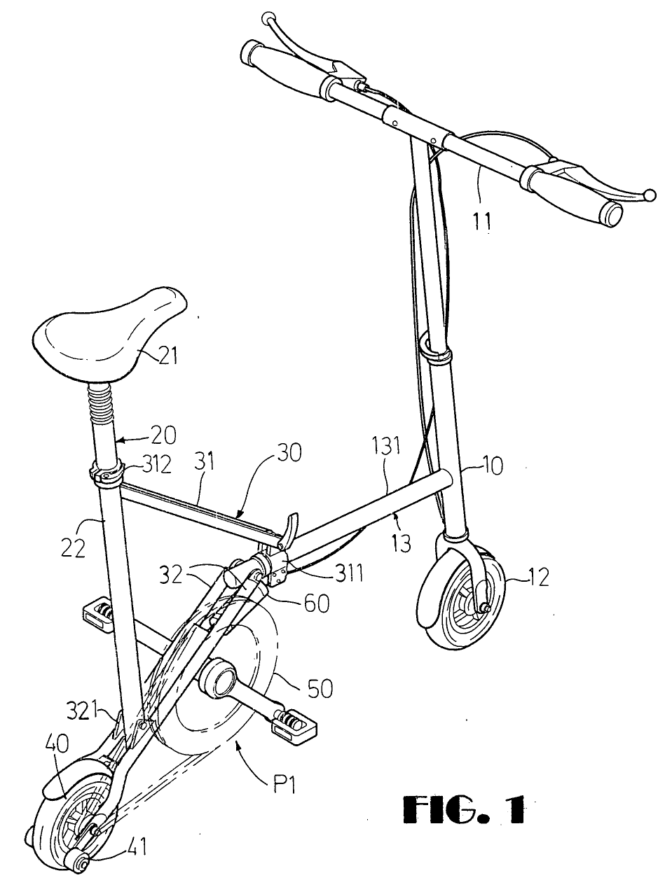

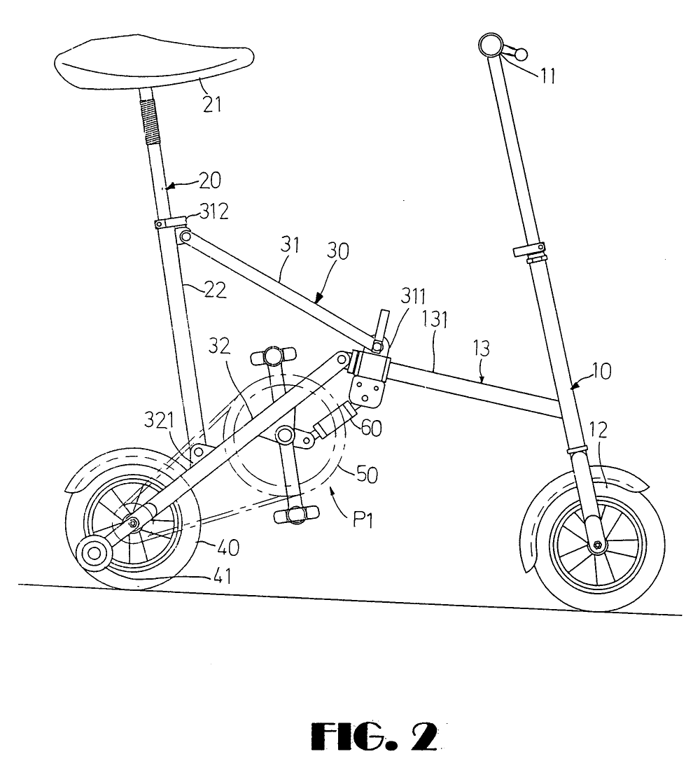

Referring to FIGS. 1 and 2, a collapsable bicycle constructed in accordance. with the invention is shown. The bicycle comprises a head portion 10, a seat portion 20, a tube portion 30, a rear wheel portion, a chain drive portion 50, and a brace portion 60. Each component will be described in detail below.

The head portion 10 comprises a pair of handlebars 11, a head tube being adapted to adjust its height, a front wheel 12, and a crossbar 13 having an outer surface 131. The seat portion 20 comprises a seat 21, a seat post, and a seat tube 22. The tube portion 30 comprises a link 31 including a first locking device 311 (e.g., quick release) at one end, the first locking device 311 being adapted to slidably sleeve on and fasten at a rear portion of the crossbar 13, a second locking device 312 (e.g., quick release) at the other end, the second locking device 312 being adapted to fasten the sliding seat post at a top end of the seat tube 22, and a pair of down tubes 32 having one ends pivotably coupled to the rear end of the crossbar 13, the down tubes 32 having a pivot point 321 pivotably coupled to a bottom end of the seat tube 22. The rear wheel portion comprises a rear wheel 40 rotatably coupled to a rear end of the down tubes 32, and two side auxiliary wheels 41 coupled to the hub of the rear wheel 40. The chain drive portion 50 is implemented as a sprocket wheel and is mounted between the rear wheel 40 and the down tubes 32. The brace portion 60 is implemented as a shock absorber coupled between the chain drive portion 50 and the first locking device 311. The provision of the brace portion 60 can increase the structural strength of the down tubes 32 and the crossbar 13. In an unfolded operating state, the chain drive portion 50 is positioned as indicated by P1.

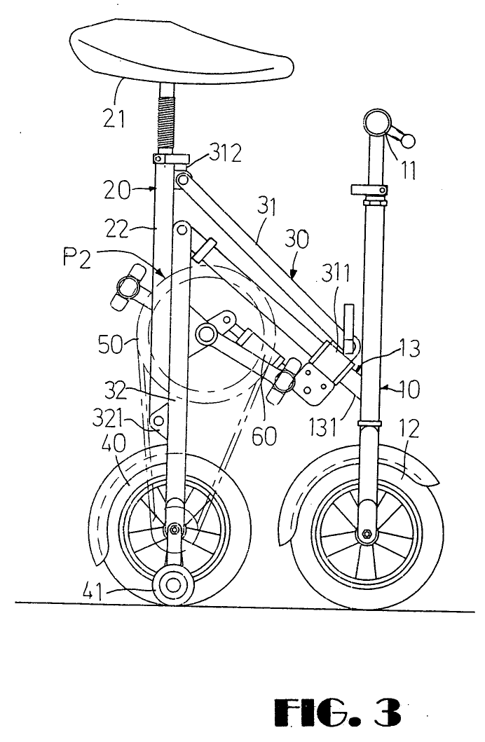

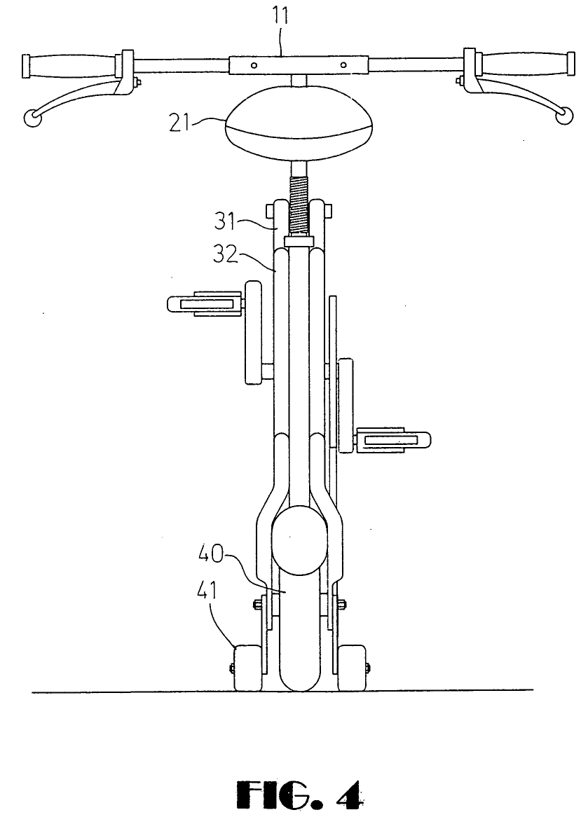

Referring to FIGS. 3 and 4, an operation of collapsing the bicycle will now be described in detail below. First, unfasten the first and second quick releases 311 and 312. Slide a portion of the seat post into the seat tube 22 if height reduction of the bicycle is desired. Slide the unfastened first locking device 311 forwardly to cause the rear wheel 40 to move forwardly by pivoting about the joining point of down tubes 32 and the crossbar 13. Also, the front wheel 12 moves rearward. Further, the down tubes 32 and the seat tube 22 move toward each other by pivoting about the pivot point 321. The sliding of the first locking device 311 will stop when the seat tube 22 is parallel to and is engaged with the down tubes 32. As shown, length of the bicycle is greatly reduced. Further, in this folded nonoperating state, the chain drive portion 50 is positioned as indicated by P2. Also, the side auxiliary wheels 41 are in contact with the ground so that a driver may stably push the bicycle to a narrow parking location. Moreover, the collapsed bicycle is convenient in storage or shipping.

While the invention herein disclosed has been described by means of specific embodiments, numerous modifications and variations could be made thereto by those skilled in the art without departing from the scope and spirit of the invention set forth in the claims.

1. A collapsable bicycle, comprising:
a head comprising a pair of handlebars, a height adjustable head tube, a front wheel, and a crossbar;
a seat assembly comprising a seat, a sliding seat post, and a seat tube;
a tube section comprising a link including a first locking device at one end slidably attached to a rear portion of the crossbar, a second locking device at a second end fastened to the seat post at a top end of the seat tube, and a pair of downward extending tubes each having first ends pivotably coupled to a rear end of the crossbar, the downward extending tubes having a pivot point coupled to a bottom end of the seat tube;
a rear wheel rotatably coupled to a rear end of the down tubes, a chain drive mounted between a sprocket wheel and the rear wheel, and
a brace coupled between the chain drive and the first locking device;
whereby unfastening the first and the second locking devices and sliding the unfastened first locking device forward will move the rear wheel forward by pivoting about the rear end of the crossbar, move the front wheel rearward, and move the down tubes toward the seat tube by pivoting about the pivot point until the seat tube is parallel to and engaged with the down tubes.

2. The collapsable bicycle of claim 1, further comprising two side auxiliary wheels coupled to a hub of the rear wheel.

3. (canceled)

4. The collapsable bicycle of claim 3, wherein the brace is a shock absorber.

5. A collapsable bicycle, comprising:
a head comprising a pair of handlebars, a height adjustable head tube, a front wheel, and a crossbar;
a seat assembly comprising a seat, a sliding seat post, and a seat tube;
a tube section comprising a link including a first locking device at one end slidably attached to a rear portion of the crossbar, a second locking device at second end fastened to the seat post at a top end of the seat tube, and a pair of downward extending tubes each having first ends pivotably coupled to a rear end of the crossbar, the downward extending tubes having a pivot point coupled to a bottom end of the seat tube;
a rear wheel rotatably coupled to a rear end of the down tubes,
a chain drive mounted between a sprocket wheel and the rear wheel, and
a shock absorber coupled between the chain drive and the first locking device;
whereby unfastening the first and the second locking devices and sliding the unfastened first locking device forward will move the rear wheel forward by pivoting about the rear end of the crossbar, move the front wheel rearward, and move the down tubes toward the seat tube by pivoting about the pivot point until the seat tube is parallel to and engaged with the down tubes.

6. The collapsable bicycle of claim 1, further comprising two side auxiliary wheels coupled to a hub of the rear wheel.
